(19) United States
(12) Patent Application Publication
(10) Pub. No.: US 2014/0020519 A1
(43) Pub. Date: Jan. 23, 2014

(54) RATCHET WRENCH

(71) Applicant: Chih-Min CHANG, Xiushui Township (TW)

(72) Inventor: Chih-Min CHANG, Xiushui Township (TW)

(21) Appl. No.: 13/804,442

(22) Filed: Mar. 14, 2013

(30) Foreign Application Priority Data
Jul. 23, 2012 (TW) 101214222

(51) Int. Cl. B25B 13/46

(52) U.S. Cl. CPC B25B 13/463
USPC 81/63.2; 81/60

(57) ABSTRACT

A ratchet wrench includes a wrench body and a ratchet rotatably mounted in a ratchet hole of the wrench body and provided with one end protruding out of the ratchet hole for connection of a driving wheel. Thus, a user can rotate the driving wheel to force the rotation of the ratchet, such that a screw nut accommodated in the ratchet can be secured or loosened quickly and conveniently.

### BACKGROUND OF THE INVENTION

1. Field of the Invention

The present invention relates generally to a ratchet wrench, and more specifically to a ratchet wrench, which can be operated conveniently.

2. Description of the Related Art

Ratchet wrench is a common hand tool to allow a user to fasten or loosen a screw nut quickly. When the conventional ratchet wrench is in use, the user holds and rotates the wrench body to force the ratchet installed in the wrench body to rotate in one-way direction by means of the lever principle, such that the screw nut accommodated in the ratchet can be driven to be fastened tight or loosened.

During the operation of the convention ratchet wrench, the user needs to rotate the wrench body continuously until the accommodated screw nut is secured or removed. However, if the accommodated screw nut is located at a narrow space or other adverse locations, the user may change different postures or angles constantly so that it will take much effort and time for the user to operate the ratchet wrench. In other words, the aforesaid conventional ratchet wrench is inconvenient to use.

### SUMMARY OF THE INVENTION

it is one objective of the present invention to provide a ratchet wrench, which can tighten or loosen a screw nut quickly and conveniently.

To achieve this objective of the present invention, the ratchet wrench provided by the present invention comprises a wrench body, a retaining ring, a ratchet assembly, an elastic member, and a driving wheel. The retaining ring is mounted in a driving portion of the wrench body and located at one end of a ratchet hole of the wrench body. The ratchet assembly includes a ratchet rotatably mounted in the ratchet hole of the wrench body and a pawl mounted in the ratchet hole of the wrench body, wherein the ratchet has an annular body with a first end protruding out of the ratchet hole of the wrench body and a second end inserted into the retaining ring, and a teeth portion arranged at an outer surface of the annular body and located between an annular flange of the wrench body and the retaining ring for engagement with the pawl. The elastic member is disposed in a receiving hole of the wrench body and stopped against the pawl for maintaining proper engagement between the ratchet and the pawl. The driving wheel is mounted on the first end of the annular body of the ratchet for driving the rotation of the ratchet. By means of the aforesaid design, when a user forces the driving wheel to rotate, the ratchet can be rotated synchronously to tighten or loosen the screw nut.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a ratchet wrench according to a first embodiment of the prevent invention;

FIG. 2 is an exploded view of the ratchet wrench according to the first embodiment of the prevent invention;

FIG. 3 is a sectional view of a part of the ratchet wrench according to the first embodiment of the prevent invention;

FIG. 4 is similar to FIG. 3, but showing that the driving wheel is screwingly connected with the ratchet;

FIG. 5 is a sectional view of a part of a ratchet wrench according to a second embodiment of the prevent invention; and

FIG. 6 is a perspective view of a part of a ratchet wrench according to a third embodiment of the prevent invention.

### DETAILED DESCRIPTION OF THE INVENTION

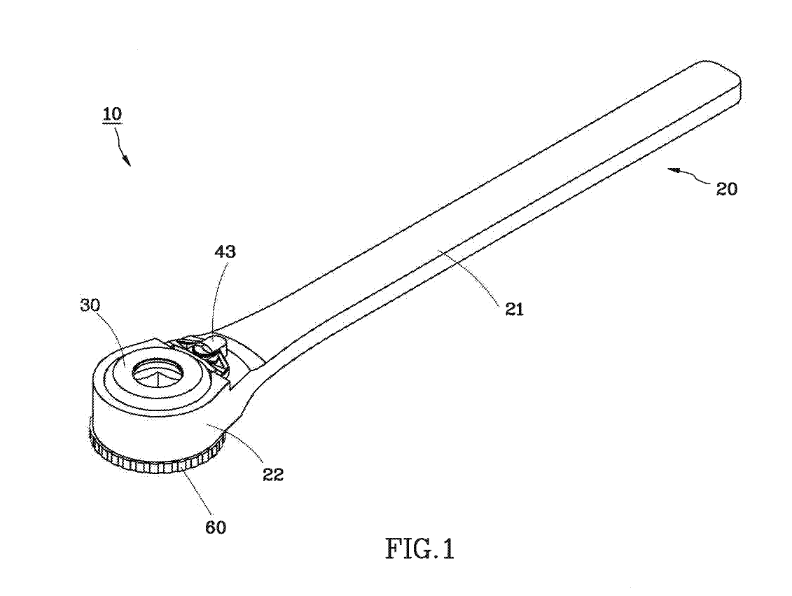

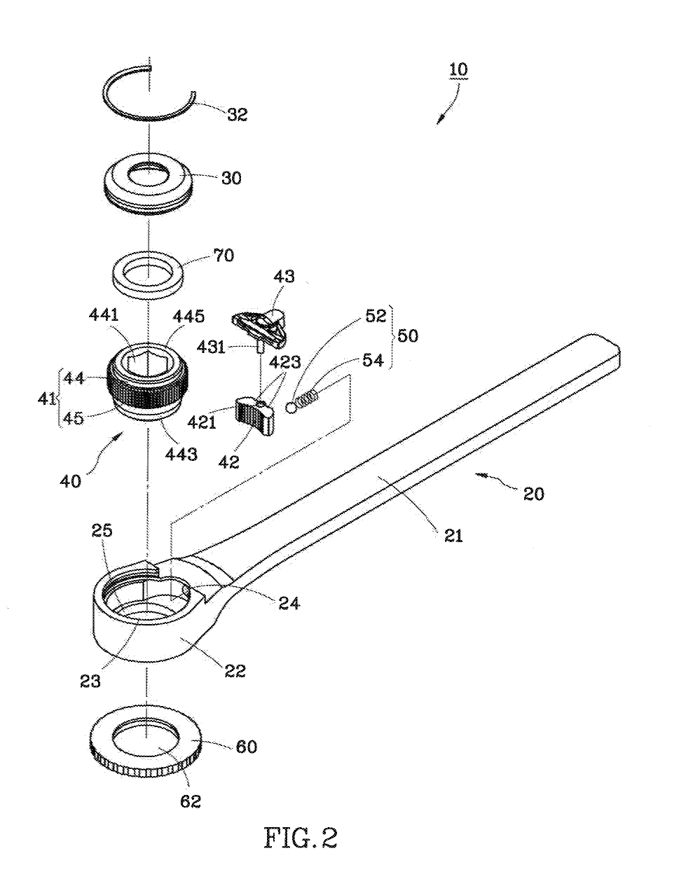

As shown in FIGS. 1 and 2, a ratchet wrench 10 in accordance with a first embodiment of the present invention comprises a wrench body 20, a retaining ring 30, a ratchet assembly 40, an elastic member 50, and a driving wheel 60.

The wrench body 20 includes a handle 21 for being held by a user, a driving portion extending from one end of the handle 21, a ratchet hole 23 through the driving portion 22, a receiving hole 24 provided on a periphery wall of the ratchet hole 23, and an annular flange 25 protruding radially from the periphery wall of the ratchet hole 23.

The retaining ring 30 is mounted in the driving portion 22 of the wrench body 20 by means of a C-shaped ring 32 and located at one end of the ratchet hole 23.

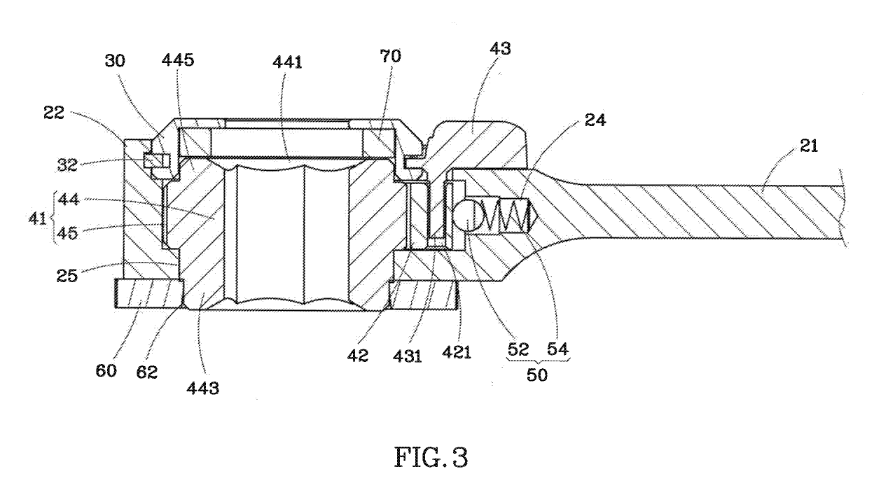

As shown in FIG. 3, the ratchet assembly 40 includes a ratchet 41 rotatably mounted in the ratchet hole 23 of the wrench body 20 and provided with an annular body 44 and a teeth portion 45. The annular body 44 has an accommodation hole 441 for accommodating a screw nut (not shown). Because the accommodation hole 441 has a diameter larger than the inner diameter of the retaining ring 30, the screw nut will be retained in accommodation hole 441 by the retaining ring 30; and further, the annular body 44 has a first end 443 protruding out of the ratchet hole 23 of the wrench body 20, and a second end 445 inserted into the retaining ring 30. The teeth portion 45 is arranged at the outer surface of the annular body 44 and located between the annular flange 25 of the wrench body 20 and the retaining ring 30. A pawl 42 is mounted in the ratchet hole 23 of the wrench body 20 and engaged with the teeth portion 45 of the ratchet 41 for limiting the rotation of the ratchet 41 to one direction only, and furthermore, the pawl 42 has an insertion hole 421 at a top side and two spaced concavities 423 at a rear side. A switching member 43 includes an insertion post 431 inserted into the insertion hole 421 of the pawl 42 such that the switching member 43 is operable by the user to switch the position of the pawl 42 for changing rotation of the ratchet 41 relative to to the wrench body 20 between two reversed directions.

The elastic member 50 is disposed in the receiving hole 24 of the wrench body 20 and provided with a steel ball 52 and a spring 54. The steel ball 52 is stopped against one of the two concavities 423 of the pawl 42 and the spring 54 has two ends respectively stopped against the steel ball 52 and the end wall of the receiving hole 24. Thus, the pawl 42 can be ensured to engage with the ratchet 41 through the elastic force applied by the elastic member 50

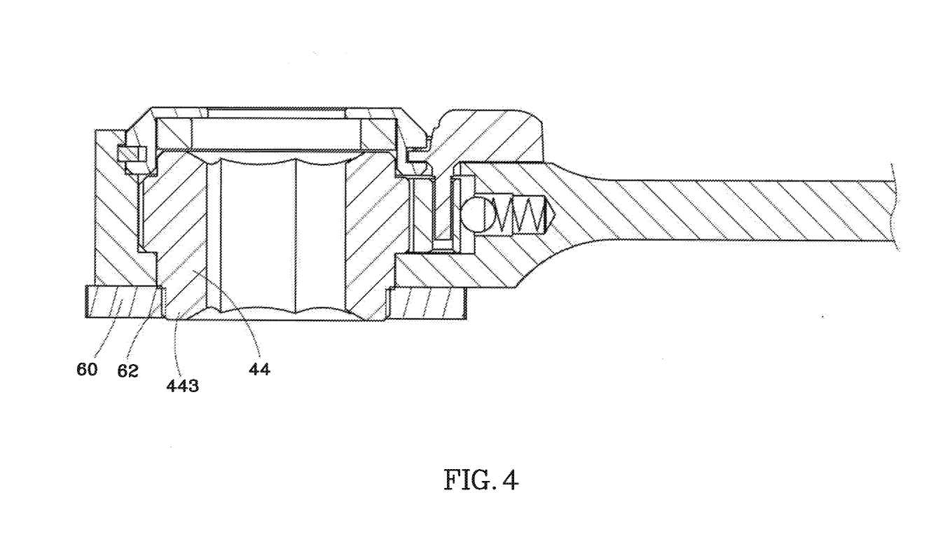

The driving wheel 60 includes a coupling hole 62. In this embodiment, the coupling hole 62 of the driving wheel 60 is interferentially fitted to the first end 443 of the annular body 44 of the ratchet 41, such that the driving wheel 60 is operable by the user to drive the rotation of the ratchet 41. However, the coupling hole 62 of the driving wheel 60 and the first end 443 of the annular body 44 of the ratchet 41 can be screwed to each other for increasing the coupling strength between the ratchet 41 and the driving wheel 60, as shown in FIG. 4.

When securing the screw nut, the user puts the screw nut in the accommodation hole 441 of the ratchet 41, and then rotates the driving wheel 60 by the thumb or forefinger to force the ratchet 41 to rotate along with the driving wheel 60 for tightening the screw nut slightly. Thereafter, the user turns the wrench body 20 to rotate the ratchet 41 until the screw nut is fastened in place. On the contrary, when removing the screw nut, the user can rotate the wrench body 20 to loosen the screw nut through the ratchet 41 slightly, and then rotate the driving wheel 60 by the thumb or forefinger to drive the rotation of the ratchet 41 until the screw nut is fully loosened.

By means of the cooperation of the ratchet 41 and the driving wheel 60, when the user would like to operate the ratchet wheel 10 in a narrow space or other adverse locations, the accommodated screw nut can be secured or loosened quickly without turning the wrench body 20 constantly, thereby attaining the purpose of saving effort and time. Further, the driving wheel 60 is set in an ergonomic position to facilitate the operation of the ratchet wrench 10.

Besides, a magnetic ring 70 can be provided between the retaining ring 30 and the second end 445 of the annular body 44 of the ratchet 41, such that the accommodated screw nut can he retained in place inside the ratchet 30 by the magnetic attractive force of the magnetic member 70, preventing the screw nut from falling.

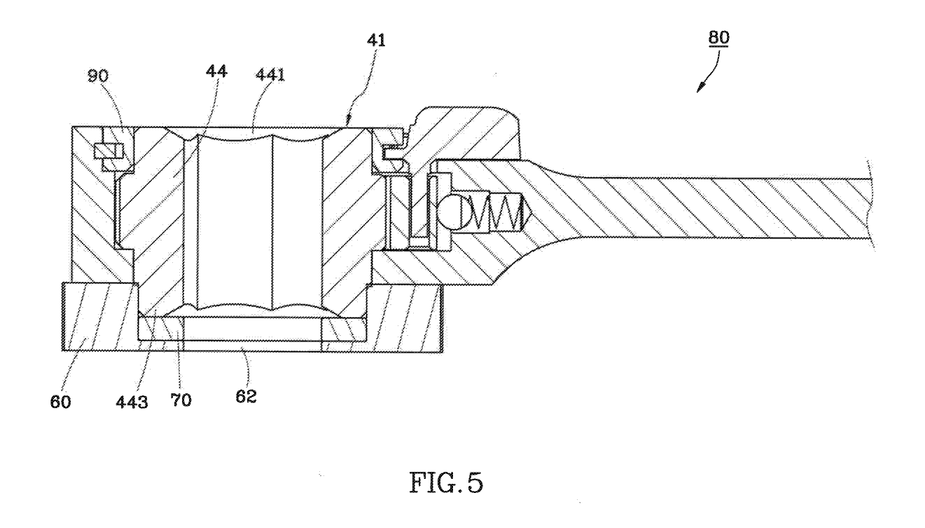

Referring to FIG. 5, the ratchet wrench 80 in accordance with a second embodiment of the present invention is shown, As illustrated, the magnetic ring 70 can be set between the first end 443 of the annular body 44 of the ratchet 41 and the driving wheel 60 for attracting the accommodated screw nut and avoiding the accommodated screw nut from falling. Further, the retaining ring 90 has an inner diameter equal to the outer diameter f the annular body 44 of the ratchet 41, so that the screw nut can pass through the accommodation hole 441 of the ratchet 41 without the obstruction of the retaining ring 90.

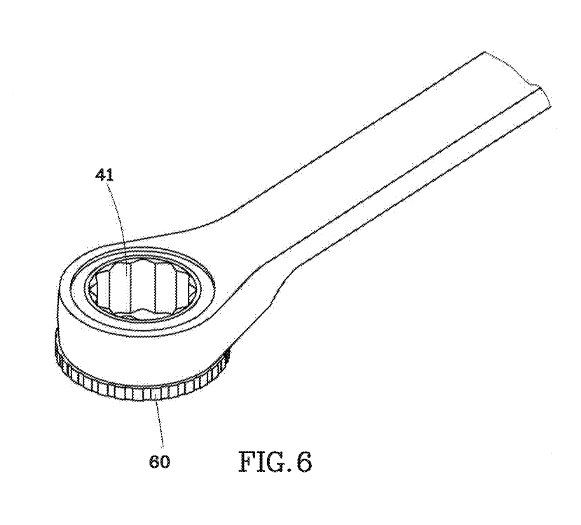

To deserve to be mentioned, the switching member 43 can be eliminated, as shown in FIG. 6. By this way, the position of the pawl 42 is unchangeable, and therefore the ratchet 41 only can be driven by the driving wheel 60 to rotate in one-way direction.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A ratchet wrench comprising:
a wrench body having a driving portion, a ratchet hole through the driving portion, a receiving hole provided on a periphery wall of the ratchet hole, and an annular flange protruded radially from the periphery wall of the ratchet hole;
a retaining ring mounted in the driving portion of the wrench body and located at one end of the ratchet hole:
a ratchet assembly having a ratchet rotatably mounted in the ratchet hole of the wrench body and a pawl mounted in the ratchet hole of the wrench body, the ratchet having an annular body with a first end protruding out of the ratchet hole and a second end inserted into the retaining ring, and a teeth portion arranged at an outer surface of the annular body and located between the annular flange of the wrench body and the retaining ring for engagement with the pawl;
an elastic member disposed in the receiving hole of the wrench body and stopped against the pawl; and
a driving wheel mounted on the first end of the annular body of the ratchet for driving rotation of the ratchet.

2. The ratchet wrench as claimed in claim 1, wherein the retaining ring has an inner diameter smaller than a diameter of an accommodation hole of the annular body of the ratchet.

3. The ratchet wrench as claimed in claim 2, wherein a magnetic ring is disposed between the retaining ring and the second end of the annular body of the ratchet.

4. The ratchet wrench as claimed in claim 1, wherein the retaining ring has an inner diameter equal to an outer diameter of the annular body of the ratchet.

5. The ratchet wrench as claimed in claim 4, wherein a magnetic ring is disposed between the first end of the annular body of the ratchet and the driving wheel.

6. The ratchet wrench as claimed in claim 1, wherein the driving wheel is interferentially fitted to the first end of the annular body of the ratchet.

7. The ratchet wrench as claimed in claim 1, wherein the driving wheel is screwingly connected to the first end of the annular body of the ratchet

8. The ratchet wrench as claimed in claim 1, wherein the elastic member includes a steel ball stopped against the pawl, and a spring having two ends respectively stopped against the steel ball and an end wall of the receiving hole.

9. The ratchet wrench as claimed in claim 8, wherein the ratchet assembly further comprises a switching member connected with the pawl for driving the pawl to stop against the steel ball through one of two spaced concavities of the pawl.

10. The ratchet wrench as claimed in claim 9, wherein the pawl has an insertion hole and the switching member has an insertion post inserted into the insertion hole.
